(19) United States
(12) Patent Application Publication
(10) Pub. No.: US 2005/0182187 A1
(43) Pub. Date: Aug. 18, 2005

(54) Polyurethane dispersions and coatings made therefrom

(76) Inventors: William A. Koonce, Dalton, GA (US); Debkumar D. Bhattacharjee, Lake Jackson, TX (US); Surendar N. Kaul, League City, TX (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/789,887

(22) Filed: Feb. 27, 2004

Related U.S. Application Data
(63) Continuation-in-part of application No. 10/777,314, filed on Feb. 12, 2004, now abandoned.

(51) Int. Cl. C08K 3/00

(52) U.S. Cl. 524/589

(57) ABSTRACT

A polyurethane having enhanced properties is made from an aqueous polyurethane dispersion having therein a nonvolatile, non-reactive, property enhancing water-soluble (NNPEW) compound such as urea. Even though the NNPEW is soluble in water, the NNPEW remains in the polyurethane after being exposed to water. In another embodiment, the NNPEW may react with a compound present in the dispersion other than the polyurethane particles of the dispersion when removing the water of the dispersion to form the polyurethane or upon subsequent heating.

### FIELD OF THE INVENTION

The invention relates to improved aqueous polyurethane dispersions. In particular, the invention relates to aqueous polyurethane dispersions having improved tackiness and coating properties.

### BACKGROUND OF THE INVENTION

Aqueous polyurethane dispersions formed from an isocyanate terminated prepolymer that is chain extended in water are well known. Generally, these polyurethane dispersions have used some amount of organic solvents to make the polyurethane dispersions. The solvent has been necessary, for example, to dissolve solid reactants used to make the dispersion, slow down the reaction with water or an added chain extender such as an amine, and inhibit the reaction of reacting particles with other particles.

In addition, solvent has been necessary to form hard, well adhered coatings formed from aqueous polyurethane dispersions. The solvent allows for the polyurethane particles to be softened such that they can spread uniformly on a substrate and interact sufficiently to bond with the substrate (i.e., not act as a hard sphere). This of course leads to volatile organic compounds evaporating into the environment.

Accordingly, it would be desirable to provide a polyurethane dispersion that has good adherence and film forming properties that avoids one or more of the problems in the prior art such as one of those described above (e.g., use of organic solvents).

### SUMMARY OF THE INVENTION

A first aspect of the invention is an aqueous polyurethane dispersion comprised of water having therein dispersed polyurethane particles and a nonvolatile non-reactive property enhancing water-soluble (NNPEW) compound. It has been surprisingly found that certain solid at ambient temperature water-soluble compounds when added to polyurethane dispersions, even though they do not react with the polyurethane, can enhance the tackiness, adherence and properties of polyurethane coatings made from the polyurethane dispersions. In addition, it has been found these can become bound into the coating and as such are not leached out from the coating with water. Another advantage is that these NNPEWs accelerate the drying rate without affecting the viscosity of the dispersion. It is believed these compounds may be bound by hydrogen bonding and the property enhancement may arise from the disruption of the hard segments within the polyurethane polymer.

A second aspect of the invention is a method of forming an improved polyurethane dispersion comprising,
(a) reacting in water an isocyanate terminated polyurethane prepolymer and a chain extending agent until substantially all of the isocyanate has been reacted to form a polyurethane dispersion and
(b) adding to the polyurethane dispersion a nonvolatile, non-reactive, property enhancing, water soluble compound to form the improved polyurethane dispersion.

A third aspect of the invention is a polyurethane comprised of a polyurethane having therein a nonvolatile, non-reactive, property enhancing water-soluble compound. Surprisingly, even though the NNPEW is water soluble and does not react with the polyurethane particles upon removal of water, for example, by heating, the NNPEW is retained in the polyurethane object, improving, for example, the elongation properties of the polyurethane object (e.g., film).

A fourth aspect of the invention is a method of forming a polyurethane object comprising:
(a) forming an object from an aqueous polyurethane dispersion comprised of water and polyurethane particles and having therein a nonvolatile, non-reactive property enhancing water soluble compound and
(b) heating the formed object to a temperature such that the nonvolatile, organic property enhancing compound decomposes or reacts with a component of the aqueous polyurethane dispersion other than the polyurethane particles forming a resultant nonvolatile compound in the polyurethane object.

The dispersion and polyurethane invention may be used in any application that polyurethanes are used. The resultant polyurethane object may be any object, such as coatings, foams, fibers, sheets, gloves, bags, containers, laminates, carpet backings, upholstery backings, sealants and adhesives.

### DETAILED DESCRIPTION OF THE INVENTION

The improved polyurethane dispersion of this invention is made by adding to an aqueous polyurethane dispersion a NNPEW compound. The polyurethane dispersion used to make the improved polyurethane dispersion may be any suitable polyurethane dispersion such as one known in the art. To this dispersion the NNPEW compound is added by any suitable method to the polyurethane dispersion to form the improved polyurethane dispersion so long as the NNPEW compound substantially fails to react with the polyurethane particles.

Generally, substantially fails to react with the polyurethane particles means that at most 1% of the NNPEW added to the dispersion reacts with the polyurethane particles, for example, when 1% NNPEW compound by weight of the total weight of the dispersion is added. Preferably, at most about 0.5%, more preferably at most about 0.1% and even more preferably at most trace amounts and most preferably none of the NNPEW reacts with the polyurethane particles.

It is also preferred to add the NNPEW as soon as possible after the polyurethane dispersion has been formed, because of the raised temperature due to the polyurethane formation reaction. Alternatively it may be added prior to use due to elevated ambient temperatures. It has been surprisingly found that the addition of the compound cools the dispersion, reducing the energy needed to cool the dispersion and helping stabilize the dispersion, for example, from coagulation of hot polyurethane particles.

The polyurethane dispersion may be, for example, an internally stabilized polyurethane dispersion. An internally stabilized polyurethane dispersion is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598. Ionic internally stabilized polyurethane dispersions are well known and are described in col. 5, lines 4-68 and col. 6, lines 1 and 2 of U.S. Pat. No. 6,231,926. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

An externally stabilized polyurethane dispersion may also be used. An externally stabilized polyurethane dispersion is one that substantially fails to have an ionic or nonionic hydrophilic pendant groups and thus requires the addition of a surfactant to stabilize the polyurethane dispersion. Examples of externally stabilized polyurethane dispersions are described in U.S. Pat. Nos. 2,968,575; 5,539,021; 5,688,842 and 5,959,027. Combinations of internally and externally stabilized polyurethane dispersion may be used.

Preferably, the polyurethane dispersion is comprised of a nonionizable polyurethane and an external stabilizing surfactant. A nonionizable polyurethane is one that does not contain a hydrophilic ionizable group. A hydrophilic ionizable group is one that is readily ionized in water such as DMPA. Examples of other ionizable groups include anionic groups such as carboxylic acids, sulfonic acids and alkali metal salts thereof. Examples of cationic groups include ammonium salts reaction of a tertiary amine and strong mineral acids such as phosphoric acid, sulfuric acid, hydrohalic acids or strong organic acids or by reaction with suitable quartinizing agents such as C1-C6 alkyl halides or benzyl halides (e.g., Br or Cl).

The polyurethane dispersion may be mixed with another polymer dispersion or emulsion so long as the majority of the dispersion is a polyurethane dispersion. Other polymer dispersions or emulsions that may be useful when mixed with the polyurethane dispersion include polymers such as polyacrylates, polyisoprene, polyolefins, polyvinyl alcohol, nitrile rubber, natural rubber and co-polymers of styrene and butadiene. Most preferably, the polyurethane dispersion is the sole polymer dispersion.

Generally, the preferred nonionizable polyurethane is prepared by reacting a polyurethane/urea/thiourea prepolymer with a chain-extending reagent in an aqueous medium and in the presence of a stabilizing amount of an external surfactant. The polyurethane/urea/thiourea prepolymer can be prepared by any suitable method such as those well known in the art. The prepolymer is advantageously prepared by contacting a high molecular weight organic compound having at least two active hydrogen atoms with sufficient polyisocyanate, and under such conditions to ensure that the prepolymer is isocyanate terminated as described in U.S. Pat. No. 5,959,027, incorporated herein by reference.

The polyisocyanate is preferably an organic diisocyanate, and may be aromatic, aliphatic, or cycloaliphatic, or a combination thereof. Representative examples of diisocyanates suitable for the preparation of the prepolymer include those disclosed in U.S. Pat. No. 3,294,724, column 1, lines 55 to 72, and column 2, lines 1 to 9, incorporated herein by reference, as well as U.S. Pat. No. 3,410,817, column 2, lines 62 to 72, and column 3, lines 1 to 24, also incorporated herein by reference. Preferred diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodi-cyclohexylmethane, and 2,4′-diisocyanatodiphenylmethane. Most preferred is 4,4′-diisocyanatodiphenylmethane and 2,4′-diisocyanatodiphenylmethane.

As used herein, the term “active hydrogen group” refers to a group that reacts with an isocyanate group to form a urea group, a thiourea group, or a urethane group as illustrated by the general reaction:

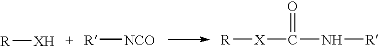

where X, is O, S, NH, or N, and R and R′ are connecting groups which may be aliphatic, aromatic, or cycloaliphatic, or combinations thereof. The high molecular weight organic compound with at least two active hydrogen atoms typically has a molecular weight of not less than 500 Daltons.

The high molecular weight organic compound having at least two active hydrogen atoms may be a polyol, a polyamine, a polythiol, or a compound containing combinations of amines, thiols, and ethers. Depending on the properties desired the polyol, polyamine, or polythiol compound may be primarily a diol, triol or polyol having greater active hydrogen functionality or a mixture thereof. It is also understood that these mixtures may have an overall active hydrogen functionality that is slightly below 2, for example, due to a small amount of monol in a polyol mixture.

Preferably, the high molecular weight organic compound having at least two active hydrogen atoms is a polyalkylene glycol ether or thioether or polyester polyol or polythiol having the general formula:

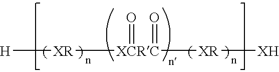

where each R is independently an alkylene radical; R′ is an alkylene or an arylene radical; each X is independently S or O, preferably O; n is a positive integer; and n′ is a non-negative integer.

Generally, the high molecular weight organic compound having at least two active hydrogen atoms has a weight average molecular weight of at least about 500 Daltons, preferably at least about 750 Daltons, and more preferably at least about 1000 Daltons. Preferably, the weight average molecular weight is at most about 20,000 Daltons, more preferably at most about 10,000 Daltons, more preferably at most about 5000 Daltons, and most preferably at most about 3000 Daltons.

Polyalkylene ether glycols and polyester polyols are preferred. Representative examples of polyalkylene ether glycols are polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Preferred polyester polyols include polybutylene adipate, caprolactone based polyester polyol and polyethylene terephthalate.

The NCO:XH ratio may be any suitable to form a polyurethane dispersion. Preferably the NCO:XH ratio is not less than 1.1:1, more preferably not less than 1.2:1, and preferably not greater than 5:1.

The polyurethane prepolymer may be prepared by a batch or a continuous process. Useful methods include methods such as those known in the art. For example, a stoichiometric excess of a diisocyanate and a polyol can be introduced in separate streams into a static or an active mixer at a temperature suitable for controlled reaction of the reagents, typically from about 40° C. to about 100° C. A catalyst may be used to facilitate the reaction of the reagents such as an organotin catalyst (e.g., stannous octoate). The reaction is generally carried to substantial completion in a mixing tank to form the prepolymer.

The external stabilizing surfactant, when used, may be cationic, anionic, or nonionic. Suitable classes of surfactants include, but are not restricted to, sulfates of ethoxylated phenols such as poly(oxy-1,2-ethanediyl)α-sulfo-ω(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins.

The polyurethane dispersion may be prepared by any suitable method such as those well known in the art. (See, for example, U.S. Pat. No. 5,539,021, column 1, lines 9 to 45, which teachings are incorporated herein by reference.)

When making the polyurethane dispersion, the prepolymer may be extended by water solely, or may be extended using a chain extender such as those known in the art. When used, the chain extender may be any isocyanate reactive diamine or amine having another isocyanate reactive group and a molecular weight of from about 60 to about 450, but is preferably selected from the group consisting of: an aminated polyether diol; piperazine, aminoethylethanolamine, ethanolamine, ethylenediamine and mixtures thereof. Preferably, the amine chain extender is dissolved in the water used to make the dispersion.

The polyurethane dispersion may have any suitable solids loading of polyurethane particles, but generally the solids loading is between about 1% to about 70% solids by weight of the total dispersion weight depending upon the application.

The NNPEW compound is a compound that does not react with the polyurethane particles to form chemical bonds with the polyurethane under typical conditions within dispersion and when forming a coating. The NNPEW compound is added to the polyurethane dispersion when substantially all of the isocyanate groups of the prepolymer used to form the polyurethane dispersion have been reacted and are no longer available to react, for example, with the NNPEW compound.

Typically, the amount of isocyanate (NCO) remaining is at most about 0.1% by weight of the polyurethane, preferably at most about 0.05%, more preferably at most about 0.025% and most preferably at most about 0.01%. It is understood that a small amount of the NNPEW may react with NCO groups of the polyurethane particles, if any are remaining. However, it is preferred that there are no NCO groups detected using infra-red absorption of NCO in the polyurethane dispersion.

The NNPEW is a non-volatile compound that is a solid at ambient temperature (i.e., ˜20° C.). Non-volatile means that upon forming, for example, a coating of the improved polyurethane dispersion, substantially all of the compound remains in the coating even after heating to a temperature above the boiling temperature of water for at time sufficient to remove the water, but below the decomposition temperature of the polyurethane. The NNPEW, however may decompose or react with a component (e.g., another NNPEW compound) other than the polyurethane particles within the dispersion and form other non-volatile compounds. For example, the NNPEW compound may be urea, which when heated past about 130° C. decomposes to form, inter alia, biuret. This newly formed non-volatile compound may or may not be soluble in water.

The NNPEW compound is water soluble, which means, herein, that at the amount that the NNPEW compound is added to the dispersion it is dissolved by the water. Generally, this means that 20 parts by weight of the NNPEW are at least dissolvable in 80 parts by weight water. Preferably the NNPEW is dissolved in an equal amount of water by weight.

Exemplary NNPEW compounds include
(a) an amido compound of the formula: 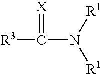
where X is NH, O or S and each R¹ is independently H or a 1-35 carbon containing monovalent radical that is aliphatic, aromatic or combination thereof, which may be substituted with up to five atoms selected from the group consisting of oxygen, nitrogen, sulfur, phosphorous, halogen and combinations thereof and R³ is —N(R¹)₂ or —C(R¹)₃;
(b) a salt of the above amido compound;
(c) a sugar; or
(d) combination thereof.

Preferably, R¹ is H, methyl or ethyl. Most preferably R¹ is H. Preferably R³ is —C(R¹)₃ or —N(R¹)₂ where R¹ is H, methyl or ethyl. More preferably R³ is —N(R¹)₂ where R¹ is H. Preferably X is O.

Examples of suitable NNPEW compounds include urea, thiourea, N,N′dimethylurea, N,N-dimethylurea, a C₆ sugars (e.g., glucose and fructose), a C₁₂ sugar (e.g., sucrose, lactose and maltose), guanidine, thioguanidine, or combination thereof. Preferably the NNPEW compound is urea, glucose, sucrose, N,N′dimethylurea, N,N-dimethylurea or combination thereof. More preferably the NNPEW is urea, sucrose or combination thereof.

The amount of NNPEW within the dispersion may vary over a large range depending on the dispersion used and the property that is desired to be enhanced. Generally, the amount of NNPEW is at least about 0.1% to about 20% by weight of the total dry weight of the dispersion. Preferably the amount of NNPEW is at least about 0.2%, more preferably at least about 0.5% by weight and more preferably at least about 1% to preferably at most about 15%, more preferably at most about 12% and most preferably at most about 10% by dry weight of the dispersion. Dry weight of the dispersion is the amount of solids remaining after the water is removed from the dispersion to form the polyurethane object.

Once the dispersion is formed a polyurethane object may be made therefrom. The polyurethane object may be made by any known method to form objects from a polyurethane dispersion. For example the dispersion may be coated upon a substrate and dried or coagulated to form a polyurethane film or coating. In addition other shapes and forms may be made in a like manner such as drawing a fiber.

When making an object from the dispersion, the water is preferably removed at a temperature that fails to decompose the polyurethane, but at a temperature that removes the water in practical times (e.g., less than about 4 hours). Generally, the temperature to remove the water from the dispersion to form the object is at least ambient temperature to about 200° C. Preferably the temperature is at least about 40° C., more preferably at least about 60° C. and most preferably at least about 80° C. to preferably at most about 180° C., more preferably at most about 160° C. and most preferably at most about 140° C.

In a preferred embodiment, the temperature to remove the water is one that does not decompose or react the NNPEW within the dispersion. For example, the temperature, when the NNPEW is urea, is at most about 130° C. However, it is sometimes advantageous to utilize a temperature that decomposes or causes the NNPEW to react with another NNPEW or other component in the dispersion (e.g., surfactant), such that a resultant nonvolatile compound is formed within the polyurethane object. This temperature where the NNPEW decomposes or reacts with another component in the dispersion other than the polyurethane particles is dependent on the particular NNPEW and other components within the dispersion so long as the temperature is below the decomposition temperature of the polyurethane.

When using the NNPEW it has been surprisingly found that the tackiness, for example, of films produced using the NNPEW may be greatly improved. Illustratively a dispersion having the NNPEW is capable of adhering to Polyvinyl chloride (PVC) substrates whereas a dispersion without the NNPEW fails to adhere well at all with PVC.

In addition, the NNPEW has also improved the tensile strength and modulus of films produced using the dispersion of the present invention. Typically, the tensile strength increases by at least about 1% compared to a like dispersion in the absence of the NNPEW. Preferably the polyurethane object of the present invention has a tensile strength that is at least about 2%, more preferably at least about 5% and most preferably 10% greater than a like object made using a dispersion lacking the NNPEW. Similarly, the polyurethane object of the present invention, typically, has a percent elongation before rupture that is at least about 2% greater than a polyurethane made using a like dispersion lacking an NNPEW. Preferably the polyurethane has a % elongation before rupture that is at least about 5%, more preferably at least about 10%, even more preferably at least about 20%, and most preferably at least about 30% greater than a polyurethane made from a like dispersion lacking the NNPEW.

Other additives such as those known in the art may be added to the polyurethane dispersion to impart some desired characteristic. Examples of such additives include rheological modifiers, defoamers, antioxidants, pigments, water insoluble fillers, dyes, and combinations thereof. These other additives may react with the NNPEW compound upon forming a polyurethane object from the dispersion and heating to remove the water from the formed polyurethane object.

### EXAMPLES

### Examples 1-4 and Comparative Example 1

Urea was added into a commercial polyurethane dispersion SYNTEGRA® YA 500 available from the Dow Chemical Company, Midland Mich., in the amounts shown in Table 1. The SYNTEGRA® YA 500 has a solids of about 56.7 percent by weight. The dispersion containing the dissolved urea was cast on a substrate as shown in Table 1. After being cast the films were dried in a convection oven at 130° C. for 20 minutes. The ease of removal and mechanical properties of these films are also shown in Table 1.

Comparative Example 1 used the same PUD and procedure to make a cast film as described above except that no urea was added. The adhesive behavior and mechanical properties of this film are shown in Table 1.

Example 3, after testing, was immersed into water to determine if the urea could be removed from the film. The film after immersion only lost 4.4 percent by weight indicating that the urea is somehow bound in the film. Finally, the leached film and other example films were subjected to DSC (Differential Scanning Calorimetry). The urea decomposition peak shows that the urea up to 5% is indistinct indicating the urea is bound in the film in some manner. Examples 3 and 4 (those containing 10 by weight urea) had distinct peak where as the leached film resembled Example 2 (5% urea loading). This indicated that the SYNTEGRA® YA 500 polyurethane films incorporated about 5% by weight of the urea into the film structure.

TABLE 1
Film Properties of Examples 1-4 and Comp. 1.

| | | Film | | | |
|---|---|---|---|---|---|
| | % Urea | Peel | Tensile | Elastic | |
| | by | off | Strength | modulus | |
| Example | weight | Ease | (psi) | (psi) | % Elongation |
| Comp. 1 | 0 | Easy | 1997 | 876 | 352 |
| 1 | 1 | Easy | 1961 | 761 | 389 |
| 2 | 5 | Easy | 2306 | 507 | 625 |
| 3 | 10 | Hard | 1611 | 546 | 497 |
| 4 | 10 | Easy* | 1384 | 548 | 479 |

*after cure

### Examples 5-7 and Comparative Example 2

A carpet backing formulation consisting of 100 parts by weight (pbw) SYNTEGRA® YA 500 (polyurethane solids), 250 pbw calcium carbonate and 0.2 ACRYSOL® RM-8W thickener, Rohm and Haas Company, Philadelphia, Pa., prepared by simple paddle stirring. The carpet backing formulation was adjusted to have solids loading of about 80% by weight.

To the carpet backing formulation was added various levels of urea. These formulations were then coated onto a carpet construction by drawing down the PUD formulation on the carpet construction. The carpet construction consisted of nylon yarn tufted into woven polypropylene fabric. The coating was dried at 130° C. in a convection oven. After drying, the coated carpet samples were reheated to 130° C. and a PVC rolled good (sheet) preheated to a temperature of 80° C. was laminated using a roller. The properties of the resulting carpet are shown Table 2.

TABLE 2
Carpet Backing Examples 5-7 and Comparative Example 2.

| | Urea | Precoat | | Tuft- | Wet | |
|---|---|---|---|---|---|---|
| | (pph by | weight | Hand | bind | Tuftbind | Lamination |
| Example | weight) | (oz./y²) | (lb) | (lb) | (lb) | to PVC |
| Comp. 2 | 0 | 32.4 | 10.8 | 10.9 | 5.9 | None |
| 5 | 3.3 | 32.4 | 10.1 | 11.8 | 6.5 | Adhered |
| 6 | 5 | 32.5 | 9.7 | 12.3 | 7.4 | Adhered |
| 7 | 10 | 32.5 | 11.3 | 15.6 | 9 | Adhered |

Precoat weight is the amount dried polyurethane present on
the carpet construction.
Hand is the amount force (lbs) to deflect a 9″ × 9″ square sample using a circular 4 point testing rig where the inner diameter span is 2.25″ and the outer span is 5.5″.
Tuftbind was determined by ASTM D1335.
Wet tuftbind was determined by ASTM D1335 except that the sample is soaked in water for 10 minutes prior to testing.

### Examples 8-11

Examples 8-11 were made in the same manner as Examples 1-4 except that sucrose was used instead of urea. The film properties of the films are shown in Table 3.

TABLE 3
Film Properties of Examples 8-11 and Comp. Ex. 1.

| | | Tensile | | |
|---|---|---|---|---|
| | % Sucrose | Strength | Elastic | |
| Example | by weight | (psi) | modulus (psi) | % elongation |
| Comp. 1 | 0 | 1997 | 876 | 352 |
| 8 | 1 | 3132 | 801 | 516 |
| 9 | 3 | 2785 | 792 | 492 |
| 10 | 5 | 2634 | 778 | 476 |
| 11 | 10 | 1542 | 753 | 320 |

### Examples 12-17 and Comparative Example 3

Examples 12-17 and comparative example 3 were prepared in the same manner as Examples 1-4 and comparative example 1, except that instead of SYNTEGRA® YA 500 polyurethane dispersion, BONDTHANE UD 220 polyurethane dispersion, available from Bond Polymers International LLC, Sea Brook, N.H., was used. This polyurethane dispersion has a solids content of about 35%, has a co-solvent and is of an aliphatic isocyanate and polyester polyol. The mechanical properties of the films of these examples are shown in Table 4 along with the particular NNPEW used.

TABLE 3
Film Properties of Examples 8-11 and Comp. Ex. 1:

| | | % NNPEW | Tensile | Elastic | |
|---|---|---|---|---|---|
| | NNPEW | by | Strength | modulus | |
| Example | used | weight | (psi) | (psi) | % elongation |
| Comp. 3 | none | 0 | 3046 | 2118 | 213 |
| 12 | Urea | 1 | 3690 | 2789 | 194 |
| 13 | Urea | 3 | 2734 | 1909 | 194 |
| 13 | Urea | 5 | 2509 | 1531 | 184 |
| 14 | Urea | 10 | 2102 | 855 | 243 |
| 15 | Sucrose | 1 | 2342 | 1597 | 213 |
| 16 | Sucrose | 3 | 2162 | 1413 | 213 |
| 17 | Sucrose | 5 | 2507 | 1643 | 228 |
| 18 | Sucrose | 10 | 2550 | 1626 | 230 |

From the Examples it is readily apparent that the properties of any particular film is dependent on the polyurethane dispersion and NNPEW compound used.

1. An aqueous polyurethane dispersion comprised of water having therein dispersed polyurethane particles and a nonvolatile non-reactive property enhancing water-soluble compound.

2. The aqueous polyurethane dispersion of claim 1, wherein the nonvolatile non-reactive property enhancing water-soluble compound is
(a) an amido compound of the formula: 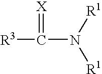
where X is NH, O or S and each R¹ is independently H or a 1-35 carbon containing monovalent radical that is aliphatic, aromatic or combination thereof, which may be substituted with up to five atoms selected from the group consisting of oxygen, nitrogen, sulfur, phosphorous, halogen and combinations thereof and R³ is —N(R¹ )₂ or —C(R¹)₃;
(b) a salt of the amido compound;
(c) a sugar; or
(d) combination thereof.

3. The aqueous polyurethane dispersion of claim 1, wherein the nonvolatile non-reactive property enhancing water-soluble compound is urea, thiourea, N,N′dimethylurea, N,N-dimethylurea, a C₆ sugar, a C₁₂ sugar, guanidine, thioguanidine, or combination thereof.

4. The aqueous polyurethane dispersion of claim 1, wherein the nonvolatile non-reactive property enhancing water-soluble compound is urea, glucose, sucrose, N,N′dimethylurea, N,N-dimethylurea or combination thereof.

5. The aqueous polyurethane dispersion of claim 1, wherein the polyurethane particles are a nonionizable polyurethane.

6. The aqueous polyurethane dispersion of claim 5, wherein the polyurethane particles are of an aromatic polyisocyanate.

7. A method of forming an improved polyurethane dispersion comprising,
(a) reacting in water an isocyanate terminated polyurethane prepolymer and a chain extending agent until substantially all of the isocyanate has been reacted to form a polyurethane dispersion and
(b) adding to the polyurethane dispersion a nonvolatile, non-reactive, property enhancing, water soluble compound to form the improved polyurethane dispersion.

8. The method of claim 7 wherein the property enhancing, water soluble compound is added immediately after the dispersion has been formed causing the temperature of the dispersion to decrease.

9. A polyurethane comprised of a polyurethane having therein a nonvolatile, non-reactive, property enhancing water-soluble compound, a decomposition product of the non-reactive, property enhancing water-soluble compound or a reaction product of the non-reactive, property enhancing water soluble compound with another compound other than the polyurethane or precursors that form the polyurethane.

10. The polyurethane of claim 9, wherein nonvolatile non-reactive property enhancing water-soluble compound is
(a) an amido compound of the formula: 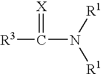
where X is NH, O or S and each R¹ is independently H or a 1-35 carbon containing monovalent radical that is aliphatic, aromatic or combination thereof, which may be substituted with up to five atoms selected from the group consisting of oxygen, nitrogen, sulfur, phosphorous, halogen and combinations thereof and R³ is —N(R¹)₂ or —C(R¹)₃;
(b) a salt of the amido compound;
(c) a sugar;
(d) a decomposition product of the aforementioned;
(e) a reaction product of the aforementioned; or
(f) a combination thereof.

11. The polyurethane of claim 9, wherein the nonvolatile non-reactive property enhancing water-soluble compound is urea, thiourea, N,N′dimethylurea, N,N-dimethylurea, a C₆ sugar, a C₁₂ sugar, guanidine, thioguanidine, a decomposition product of the aforementioned, a reaction product of the aforementioned or combination thereof.

12. The polyurethane of claim 9, wherein the nonvolatile non-reactive property enhancing water-soluble compound is urea, glucose, sucrose, N,N′dimethylurea, N,N-dimethylurea, a decomposition product of the aforementioned, a reaction product of the aforementioned or combination thereof.

13. The polyurethane of claim 9, wherein the polyurethane has therein the nonvolatile, non-reactive, property enhancing water-soluble compound.

14. The polyurethane of claim 13, wherein the nonvolatile, non-reactive, property enhancing water-soluble compound is urea, glucose, sucrose, N,N′dimethylurea, N,N-dimethylurea or combination thereof.

15. The polyurethane of claim 9, wherein the polyurethane is tackier than a like polyurethane without the nonvolatile, non-reactive, property enhancing water-soluble compound.

16. The polyurethane of claim 13, wherein the nonvolatile, non-reactive, property enhancing water-soluble compound remains in the polyurethane after being exposed to water.

17. The polyurethane of claim 9, wherein the % elongation of the polyurethane is at least about 5% greater than a like polyurethane lacking the nonvolatile, non-reactive, property enhancing water-soluble compound.

18. The polyurethane of claim 9, wherein the tensile strength of the polyurethane is at least about 5% greater than the tensile strength of a like polyurethane lacking the nonvolatile, non-reactive, property enhancing water-soluble compound.

19. A method of forming a polyurethane object comprising:
(a) forming an object from an aqueous polyurethane dispersion comprised of water and polyurethane particles and having therein a nonvolatile, non-reactive property enhancing water soluble compound and (b) heating the formed object to a temperature such that the nonvolatile, organic property enhancing compound decomposes or reacts with a component of the aqueous polyurethane dispersion other than the polyurethane particles forming a resultant nonvolatile compound in the polyurethane object.

20. The method of claim 19, wherein the NNPEW reacts with an additive selected from the group consisting of rheological modifiers, defoamers, antioxidants, pigments, water insoluble fillers, dyes, and combinations thereof.

21. The method of claim 19 wherein the NNPEW is urea, thiourea, N,N′dimethylurea, N,N-dimethylurea, a C₆ sugar, a C₁₂ sugar, guanidine, thioguanidine, or combination thereof.
